(19) United States
(12) Patent Application Publication
(10) Pub. No.: US 2010/0253933 A1
(43) Pub. Date: Oct. 7, 2010

(54) IN-LINE MERCURY DETECTOR FOR HYDROCARBON AND NATURAL GAS

(76) Inventors: Paul GUIEZE, Fontenailles (FR); Bradley MARTIN, ST FARGEAU PONTHIERRY (FR); Robert SCHROEDER, Cambridge, MA (US)

Correspondence Address: SCHLUMBERGER OILFIELD SERVICES, 200 GILLINGHAM LANE, MD 200-9, SUGAR LAND, TX, 77478, US

(21) Appl. No.: 12/708,619

(22) Filed: Feb. 19, 2010

Related U.S. Application Data
(63) Continuation-in-part of application No. PCT/EP2008/010812, filed on Dec. 18, 2008.
(60) Provisional application No. 61/014,688, filed on Dec. 18, 2007.

(51) Int. Cl. G01N 21/31

(52) U.S. Cl. 356/51; 356/440; 356/433

(57) ABSTRACT

A method and a device are presented for measuring the mercury content of hydrocarbon and natural gases in a continuous mode and in-situ in a gas production line in a real time mode, comprising diverting a gas sample from the gas production line in an optical flexible measuring cell for optical detection of the mercury present in the gas production line.

### RELATED APPLICATIONS

The present application is a continuation-in-part of International Application No. PCT/EP2008/010812, “IN-LINE MERCURY DETECTOR FOR HYDROCARBON AND NATURAL GAS,” filed 18 Dec. 2008, which claims the benefit of U.S. Provisional Patent Application No. 61/014,688, “IN-LINE MERCURY DETECTOR FOR HYDROCARBON AND NATURAL GAS,” filed 18 Dec. 2007. Each of these applications are incorporated by reference herein in their entirety.

### BACKGROUND

1. Field of the Invention

The invention generally relates to the detection of mercury in hydrocarbon and natural gases.

2. Background Art

Elemental mercury is frequently present in significant quantity in hydrocarbon reservoirs, and due to its physical properties and vapor pressure, it is produced in the natural gas phase.

The presence of mercury in the natural gas phase presents serious health and safety issues. For instance, mercury can generate amalgams with some common metal elements such as aluminum, copper, silver, and gold. It has been suspected of causing stress cracking in titanium alloys resulting in catastrophic failure of vessels. Mercury also attacks the central nervous system of humans and accumulates in their liver and kidneys.

For these reasons, oil and gas producers wish to better monitor the mercury content in hydrocarbon fluids and more generally in natural gases. Mercury analysis is well known. Mercury is naturally present on the earth, and due to the toxicity of its vapor and molecule species (e.g., salts and organometallic elements) analytical methods have been developed very early.

Known methods for determining mercury concentration in various matrices (gas, liquid, or solids) include gravimetry, micrometry, radiometry, titrimetry, colorimetry, fluorometry, atomic absorption spectrometry (AAS), atomic fluorescence spectrometry (AFS), atomic emission spectrometry (AES) (e.g., spectrography, inductive coupled plasma, microwave induced plasma, direct current plasma), neutron activation analysis (NAA), X-ray fluorescence (XRF), electron-probe micro-analysis (EPMA), proton induced X-ray emission (PIXE), mass spectrometry, gas chromatography, electrochemical methods (e.g., polarography, voltametry, amperometry, etc.), and other miscellaneous methods. According to its physical properties, mercury is a mono-atomic vapor and therefore, AAS is the most popular method for mercury measurements, which has been reported as early as 1930.

Most of these methods are only used in the laboratory and are not adapted to be used in an oilfield environment for on-site, real time measurements. Additionally, they are typically performed on a gas sample taken in a non-continuous manner.

Mercury concentration analysis in gas is generally performed by either atomic absorption spectrophotometry or by fluorescence atomic absorption spectrophotometry. When applying these techniques, the main mercury emission wavelength (253.7 nm) is generally chosen. In some instruments, another wavelength, 184.9 nm, which is said to be more sensitive to mercury atoms, is also used.

When using atomic absorption spectrophotometry or fluorescence atomic absorption spectrophotometry, the mercury is generally trapped by amalgamation on gold or silver for both concentration and preventing matrix interaction during analysis. Generally, such techniques involve many steps that are performed in a non continuous manner, e.g., sampling, analysis, etc. Typically, a gas sample is taken from a gas stream containing mercury, the gas sample is then concentrated in mercury, and the mercury content is measured.

In the oil and gas production, the sampling using gold amalgamation and further analysis either at the well site or in a remote lab is used. As stated above, the available equipments are either limited to sampling and analysis in a sequence, or they are not sensitive enough to achieve the desired detection limit (i.e., <1 ng/m³). Furthermore, mercury vapor is generally heavy and the production mechanisms in the reservoir are not completely understood. Also mercury concentration may vary over time as it is not produced at constant concentration. It is hypothesized that the mercury vapor could be produced as puffs or slugs, which could explain the variations between samples.

Physically, conventional analytical cells used in hydrocarbon gas analysis have a limited optical path length due to instrument dimensional constraints. This is a limiting factor for traces or ultra-traces analysis because of the short interaction length of the light with the gas.

In infrared spectroscopy, as applied in oil and gas production, long optical path length cells exist where the gas sample is trapped in a large cylinder. The base walls of the cylinder are made of specially designed mirrors, which allow the light beam to bounce several times, thus increasing the optical path length. However, this type of cell needs larger volumes of gas, thus requiring more physical space. Furthermore, the sample to be analyzed has a long resident time within the measuring cell, which is opposed to a continuous measurement.

Therefore, it would be highly desirable to provide an apparatus and a method having increased sensitivity and allowing for continuous measurement of the mercury content of hydrocarbon and natural gases during a well test or production.

### SUMMARY OF INVENTION

According to a first aspect, the invention relates to a mercury analyzing apparatus for measuring mercury content of a gas for use in a gas production line. The mercury analyzing apparatus comprising: a light source for emitting light at a predetermined wavelength adapted for optical detection of mercury; a gas inlet; a gas outlet; an optical flexible measuring cell made of a material enabling internal reflection of the light at the predetermined wavelength, the optical flexible measuring cell being connected between the gas inlet and the gas outlet, wherein a gas sample is diverted from the gas production line to the optical flexible measuring cell through the gas inlet; and a detector for detecting the light transmitted from the light source through the gas sample in the optical flexible measuring cell in order to estimate the mercury content of the gas.

The mercury analyzing apparatus may further comprise an optical flexible reference cell for flowing a natural gas sample without mercury as a reference. The apparatus may further comprise an optical flexible calibrating cell comprising liquid mercury for calibrating the detector. In addition, the effective wavelength may be one of 253.7 nm and 184.9 nm.

The mercury analyzing apparatus may include an optical flexible measuring cell comprising a first window for communicating the light from the light source into the optical flexible measuring cell and a second window for communicating the light from the optical flexible measuring cell to the detector, the first window and second window being transparent to the predetermined wavelength and adapted to seal against pressure of the gas sample. The first window and second window may be made of quartz. The light source may be one of a mercury lamp and a light emitting diode.

The mercury analyzing apparatus may further comprise a filter for filtering undesirable wavelengths emitted by the light source. Additionally, the apparatus may comprise a lens or a collimator for directing the effective wavelength into a hollow optical fiber. It should be noted that the apparatus may measure mercury content of the gas continuously and in real time as gas is flowing through the gas production line.

According to a second aspect, the invention relates to a method for measuring mercury content of a gas in a gas production line, the method comprising: diverting a portion of a gas from a gas production line to an optical flexible measuring cell for optical detection of the mercury content of the gas; transmitting light having a predetermined wavelength through the portion of the gas in the optical flexible measuring cell; and detecting the transmitted light for providing an electrical signal indicative of the mercury content of the gas. Such method may be performed continuously and in real time as gas is flowing through the gas production line.

The method may further comprise the steps of: flowing a mercury free gas sample through an optical flexible reference cell as a reference; and measuring the absorption of the portion of the gas from the gas production line and of the mercury free gas sample. The mercury free gas sample may be provided by removing the mercury from a second gas sample using a gold trap.

In addition, the method may further comprise the step of calibrating the detector using an optical flexible calibrating cell comprising liquid mercury. Calibrating the detector may comprise measuring the concentration of the liquid mercury at a fixed temperature.

### BRIEF DESCRIPTION OF DRAWINGS

FIG. 1 shows a sampling line with an optical flexible measuring cell of the mercury analyzing apparatus according to embodiments disclosed herein.

FIG. 2 shows a schematic view of the mercury analyzing apparatus according to embodiments disclosed herein installed on a gas production line.

FIG. 3 shows a schematic view of a detail of the optical flexible cell including optical and pneumatic connections.

FIG. 4 illustrates the mercury analyzing apparatus according to a preferred embodiment disclosed herein.

### DETAILED DESCRIPTION

Exemplary embodiments of the present disclosure will now be described in detail with reference to the accompanying Figures. Like elements in the various Figures are denoted by like reference numerals for consistency.

In general, embodiments of the present disclosure relate to an apparatus and a method for optically detecting the concentration of mercury of gas flowing through a gas production line. More specifically, embodiments of the present disclosure provide methods and apparatus for continuously sampling the gas and obtaining a signal that is proportional to the content of mercury in the gas in a real-time and/or continuous mode. The relation between the size of the apparatus and the measuring path length is optimized, i.e., the apparatus according to embodiments disclosed herein is designed in a way that its overall size is minimized while the measuring path length is maximized.

The invention is based on atomic absorption spectrophotometry, and may include contaminant absorption suppression as well as calibration without any need of elemental mercury manipulation.

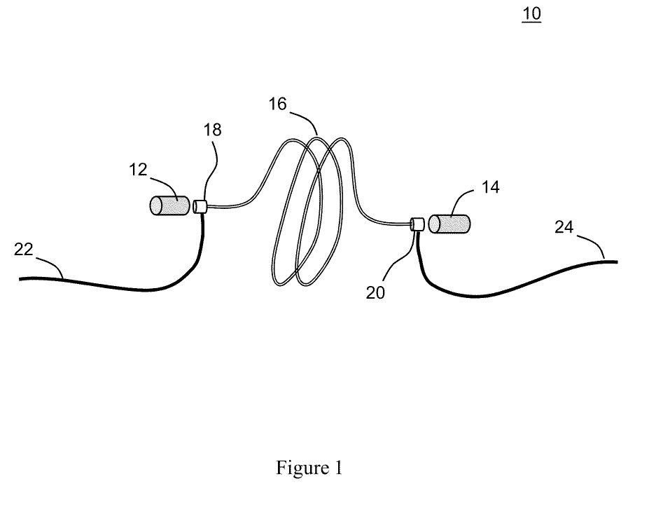

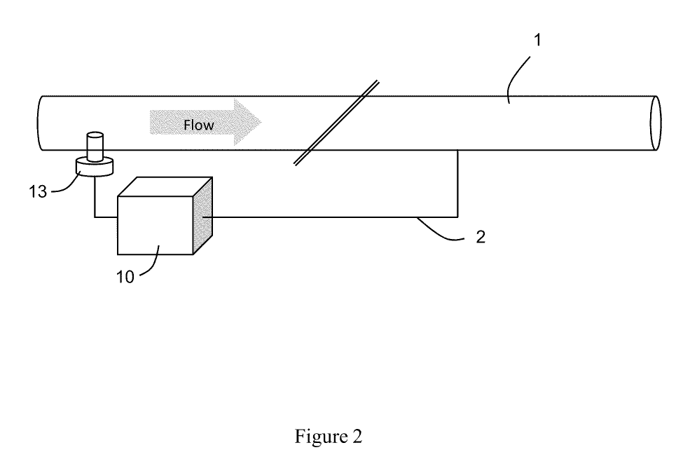

FIG. 1 shows the principle of a mercury analyzing apparatus 10 according to embodiments of the present disclosure. The apparatus 10 includes a light source 12, a detector 14, and a flexible measuring cell 16 having a first end 18 and a second end 20, whereby the length of the cell 16 is much longer than the distance of the first end 18 to the second end 20. The measuring cell 16 may also be called a flexible optical. The apparatus 10 further comprises a gas inlet 22 and a gas outlet 24. The gas inlet 22 connects the first end 18 of the cell 16 to the gas production line 1 as shown in FIG. 2 so as to constitute a sampling line 2. The sampling line 2 is used to divert a portion of gas, referred to herein as a gas sample, streaming from the production line 1 for further analysis of the gas in apparatus 10. The gas outlet 24 is connected to an exhaust line (not shown).

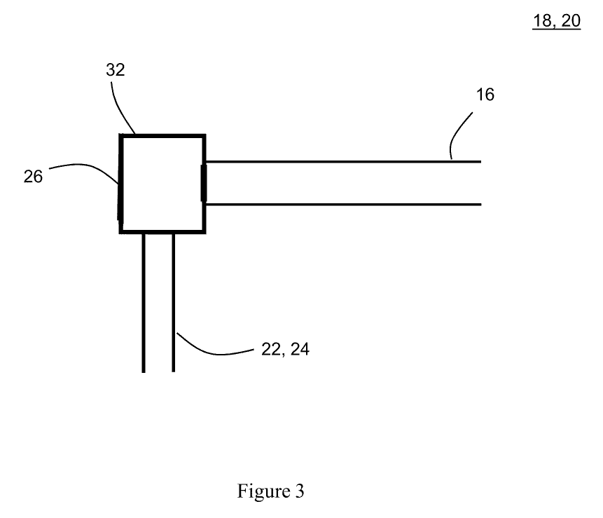

Referring now to FIG. 3, an illustration of either the first end 18 or the second end 20 of the cell 16 is shown in more detail. The pneumatic and optical connections are illustrated. According to embodiments disclosed herein, the cell end 18, 20 comprises a transparent window 26 that is adapted to transmit light at an effective wavelength and to seal against the pressure of the gas sample. The effective wavelength is chosen so as to be approximate to the emission wavelength of mercury. In a preferable embodiment, the window 26 is made of quartz. Thus, light from the light source 12 having the effective wavelength is injected through the window 26 of the first end 18 of the cell 16, and the detector 14 detects light transmitted through the transparent window 26 of the second end 20 of the cell 16. The absorption of the light is proportional to the number of mercury atoms present in the gas sample. The detector 14 provides an electrical signal that is indicative of the content of mercury in the gas sample.

Still referring to FIG. 3, it is also shown how the gas inlet 22 or the gas outlet 24 is connected to the cell 16. Gas from the gas production line 1 is sampled into the cell 16 through the gas inlet 22, flows through the cell 16 and is exhausted through the gas outlet 24. The gas sample is flowing through the cell 16 under given pressure and temperature conditions. The exhaust line of the apparatus 10 may either vent the gas sample to atmosphere via an exhaust facility such as a gold trap and a H₂S trap, or send it back to the production line 1 at a lower pressure point (downstream). Due to the small volume of the cell 16, the quantity of exhausted gas is minimized.

The gas inlet and outlet 22, 24, the measuring cell 16, and the transparent window 26 may be assembled by bonding. High accuracy will prevent any misalignment. A connector element 32 as shown in FIG. 3 may be used. The measuring cell 16 temperature may be set at various degrees to obtain different vapor concentrations in mercury atoms.

According to the invention, the gas sample is diverted continuously from the main stream (e.g., the gas production line) to the analyzing apparatus 10 in the sampling line 2. Advantageously, the sampling line 2 may include a separation device that prevents any liquid droplets or solid particles entering the measuring cell 16. The temperature of the measuring cell 16 may also be controlled in order to avoid heavy component condensation. The pressure in the sampling line 2 is controlled to be compatible with the measuring cell 16. Preferably, the pressure is at production line conditions, but may be dropped to avoid damage of the measuring cell 16.

The absorption of light having the effective wavelength λ is described by the Beer-Lambert law:

I_{(λ,X)}=I_{0(λ)}×e^{-αXγ},

where I₀ is the incident light intensity, I is the recovered light intensity that is measured by the detector 14, α is the absorption coefficient in m⁻¹, X is the light path length in m, and γ is the density of the absorbing atoms or molecules in mol/m³.

The apparatus 10 according to the invention overcomes the drawbacks of the conventional methods as described above. According to one or more embodiments disclosed herein, the measuring cell 16 is made of a long capillary flexible tube. The sample flows through the cell 16 constantly. It may also be trapped if static measurements are needed.

According to a preferred embodiment, the light source 12 has an effective wavelength that corresponds to the main absorption line of mercury, i.e., 253.7 nm. The skilled person will appreciate that the choice of the effective wavelength is made according to the material of the capillary, due to the transmission cut-off of most material used for the cells. Thus, other wavelengths may be chosen, such as 184.9 nm. The light source 12 may include, for example, a mercury lamp or a light emitting diode (LED) emitting at the effective wavelength, i.e., the emission wavelength of mercury.

The capillary material is selected according to its refractive index such that most of the UV light having the effective wavelength (e.g., 253.9 nm or 184.9 nm) is reflected. As in a light pipe, the incident light from the light source 12 is trapped if the incident angle and the index of refraction (i.e., the limit angle for total internal reflection) are chosen accordingly. Thus, the light is guided through the cell 16 from the first end 18 to the second end 20. The cell 16 may be coiled or bent to a certain limit without modifying significantly the light transmission.

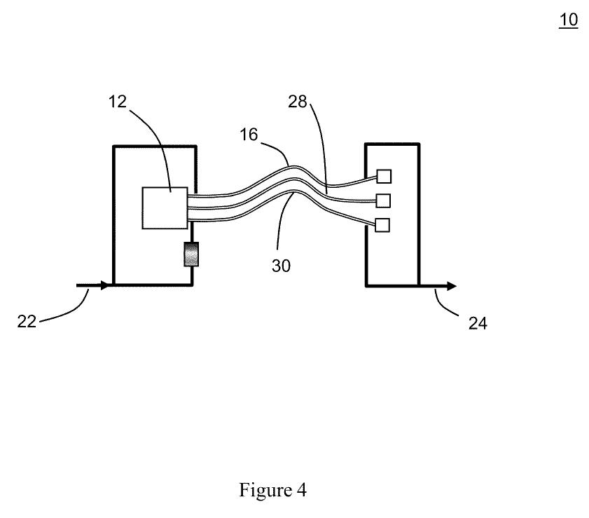

Referring now to FIG. 4, a preferred embodiment of the apparatus 10 according to the present disclosure is shown. The mercury analyzing apparatus 10 comprises a second optical cell 28. The reference cell 28 preferably has the same geometry as the measuring cell 16, i.e., the same length, width, and is made of the same material. The reference cell 28 serves as a reference measurement channel, where a mercury free gas sample is flowing at the same pressure and temperature conditions as in the measuring cell 16. The gas sample flowing through this reference channel first passes through a gold trap (not shown) for removing all mercury. This provides a blank gas (i.e., mercury free) that allows for a blank reference measurement. It is thus possible to take into account all possible contaminant or parasite absorption that may originate, for example, from aromatic molecules.

The blank, mercury-free gas sample is obtained by flowing gas from the gas production line 1 through a gold trap that is capable of collecting all mercury by amalgamating. The mercury-free gas sample has, except for the content of mercury, the same composition and characteristics as the gas sample that is analyzed in the measuring cell 16.

The gold trap is sufficiently sized to allow for high levels of mercury and long flow periods. Once the trap is saturated, it may be regenerated by heating to liberate all trapped mercury.

Still referring to FIG. 4, the analyzing apparatus 10 according to a preferred embodiment may comprise a third flexible cell 30. The third flexible cell 30 is a calibration cell used to calibrate apparatus 10. The calibration cell 30 contains liquid mercury in a known, very small amount within an inert atmosphere (e.g., argon). The cell 30 is closed to avoid any external contact with mercury, and its temperature is controlled to ensure a known mercury vapor concentration in the atmosphere of the cell 30. The mercury content in the calibration cell 30 may be known by measuring the temperature within the cell 30, which determines the mercury vapor concentration. Due to the implementation of this internal calibration, any risk for humans and environment is prevented because additional standard mercury samples are not needed.

The measuring, reference, and calibration cells 16, 28, and 30 may be made of a hollow fused silica tube or fiber with a core of a given diameter. In the measuring and reference cells 16 and 28, the gas flows continuously, and at the same time, the light is transmitted through the core of the fiber and thus through the gas. The hollow fused silica tube is made of a material that allows the tube to be flexible such as fused silica reinforced by a polyimide film. One example of a hollow fiber that may be used is described in U.S. Pat. No. 6,735,369 issued to Machida Endoscope Co., Ltd., which is incorporated herein by reference for all purposes and to the extent that it does not contradict the disclosure of the present invention. A commercially available example of a hollow silica waveguide fiber that may be used as the measuring, reference, and calibration cells 16, 28, and 30 is marketed by Polymicro Technologies of Phoenix Ariz. The hollow optical fiber has a hollow core portion that may include several inner periphery dielectric, metal and/or plating layers. The hollow optical fiber may further comprise an outer jacket tube to which are laminated the layers. A dielectric layer may, for example, be formed of calcium fluoride or yttrium fluoride. A metal layer may, for example, be formed of silver or any other metal such as gold. A plating layer may, for example, be formed of nickel and adapted to reinforce the metal and dielectric layers. The outer jacket tube may, for example, be formed of thermally contracting resin. Such a tube may be arranged in a number of possible configurations, such as a flat coil. A person having sufficient skill in the art will appreciate that other flexible materials having the appropriate refractive index may be chosen.

Alternatively, a photonic crystal fiber may be used for the reference and calibration cells 16, 28 and 30. Such photonic crystal fibers (PCF) are specialty band-gap optical fibers that have a hollow core, instead of a doped glass material. This hollow core is surrounded by a cladding that is manufactured with an array of tens to hundreds of smaller holes in it. From the size and arrangement of the holes inside the surrounding cladding, a photonic band gap is formed inside the hollow core that allows wavelengths of light to propagate and a “forbidden zone” where other wavelengths cannot. It is the optical equivalent of a solid state electronic band gap device.

The PCF fibers can be manufactured in long fiber lengths, and since the hollow core can be filled with gas, and the path length is the core of the fiber, a highly attenuating optical cell can be made from such PCF fiber. With appropriate ‘T’ like gas-optical connections, the PCF fiber can confine the UV light efficiently within the core and make an excellent long path length optical cell for gas absorption measurements of Hg gas in real time. This overcomes the limitations of other hollow fibers, such as made from Teflon AF2400, which is only suitable for liquid spectroscopy. Moreover, even though the diameter of the hollow core is typically small for PFC fibers, the pressures could be adjusted to increase flow rate, and hence the responsiveness of the resulting analyzing apparatus.

The hollow fiber, whether a fused silica tube or PCF fiber, should be of sufficient length to contain an effective amount of the gas to be analyzed to be able to perform the mercury analysis. In the case of a PCF fiber, perhaps 10 to 25 meters of optical UV path length is required to achieve a good optical density for absorption spectroscopy of the mercury, i.e. 1 nanogram/cm³. The light absorption by the mercury contained in the gas is then measured. While a PCF fiber used as the measuring, reference, and calibration cells 16, 28, and 30 can be made from silica, it may also be made of sapphire. Such a material is more robust than silica in withstanding the corrosive effects of borehole gases or fluids under elevated pressures and temperatures.

In the embodiment as shown in FIG. 1, the first and the second end 18, 20 of the cell 16 are placed close to each other with respect to the length of the cell 16. This considerably reduces the size of the apparatus 10 so that it may be arranged on a single board (emission source, detector, associated optics and electronics).

According to preferred embodiments of the present disclosure, the real-time mercury analyzing apparatus 10 may further comprise an in-line filter 13, as shown in FIG. 2. The in-line filter 13 retains all condensate droplets and solid particles. The real-time mercury analyzing apparatus 10 may further comprise optical and collimation elements such as mirrors, semi-transparent mirrors, lenses, filters, etc. for distributing the incident light from the light source 12 between the three cells and for collecting the transmitted light on the detector(s) 14, electronics or a battery for power supply, signal processing and transmission means, and a housing. The apparatus 10 may also comprise more than one detector 14 for detecting the transmitted light from the measuring cell 16 and the reference cell 28 (not shown). The detectors 14 may comprise low-energy type detectors (e.g., semi-conductor detectors) so that the total power supply needed for the analyzer is limited.

Being used in an explosive zone, the mercury analyzing apparatus 10 according to embodiments disclosed herein is designed to be in accordance with standard industrial regulation, such as ATEX zone 1. Further, the apparatus 10 is built according to safety standards for being operated with corrosive gases (e.g., H₂S, CO₂). Specifically, all elements of the apparatus 10 such as the light source 12, collimation lenses, semi-transparent mirrors, cells, detectors, and electronics may be designed as intrinsically safe equipment for being compatible with explosive zone 1 operation (ATEX zone 1), or the housing of the apparatus 10 may be explosion-proof.

The electrical signals provided by the detector(s) 14 may be communicated using conventional data acquisition and communication systems (e.g., 4-20 mA current loop, Modbus, fieldbus, etc.). The communication may also be wireless using available wireless communication systems.

The method and apparatus according to the present disclosure provide in real-time an accurate and absolute mercury concentration directly linked to the thermodynamic properties of mercury. The method may be implemented during well testing or production before or after any application of surface separation technology, i.e., they are equally applicable to measuring mercury concentration in multiphase gases or in separated gas phases. In addition, it avoids liquid mercury samples manipulations for calibrations.

While the invention has been described with respect to a limited number of embodiments and examples, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A mercury analyzing apparatus for measuring mercury content of a gas for use in a gas production line, comprising:
a light source for emitting light at a predetermined wavelength adapted for optical detection of mercury;
a gas inlet;
a gas outlet;
an optical flexible measuring cell made of a material enabling internal reflection of the light at the predetermined wavelength, the optical flexible measuring cell being connected between the gas inlet and the gas outlet, wherein a gas sample is diverted from the gas production line to the optical flexible measuring cell through the gas inlet; and
a detector for detecting the light transmitted from the light source through the gas sample in the optical flexible measuring cell in order to estimate the mercury content of the gas.

2. The apparatus according to claim 1, further comprising an optical flexible reference cell for flowing a natural gas sample without mercury as a reference.

3. The apparatus according to claim 1, further comprising an optical flexible calibrating cell comprising liquid mercury for calibrating the detector.

4. The apparatus according to claim 1, wherein the effective wavelength comprises one of 253.7 nm and 184.9 nm.

5. The apparatus according to claim 2, wherein the optical flexible measuring cell further comprises a first window for communicating the light from the light source into the optical flexible measuring cell and a second window for communicating the light from the optical flexible measuring cell to the detector, the first window and second window being transparent to the predetermined wavelength and adapted to seal against pressure of the gas sample.

6. The apparatus according to claim 5, wherein the first window and second window are made of quartz.

7. The apparatus according to claim 1, wherein the light source comprises one of a mercury lamp and a light emitting diode.

8. The apparatus according to claim 1, further comprising a filter for filtering undesirable wavelengths emitted by the light source.

9. The apparatus according to claim 2, further comprising a lens or a collimator for directing the effective wavelength into a hollow optical fiber.

10. The apparatus according to claim 1, wherein measuring the mercury content of the gas may be preformed continuously and in real time as gas is flowing through the gas production line.

11. The apparatus according to claim 1, wherein the optical flexible measuring cell is a PCF fiber having a hollow core through which said gas sample is diverted.

12. The apparatus according to claim 1, wherein the PCF fiber is formed of one of silica and sapphire

13. A method for measuring mercury content of a gas in a gas production line, the method comprising:
diverting a portion of a gas from a gas production line to an optical flexible measuring cell for optical detection of the mercury content of the gas;
transmitting light having a predetermined wavelength through the portion of the gas in the optical flexible measuring cell; and
detecting the transmitted light for providing an electrical signal indicative of the mercury content of the gas.

14. The method according to claim 11, further comprising:
flowing a mercury free gas sample through an optical flexible reference cell as a reference; and
measuring the absorption of the portion of the gas from the gas production line and of the mercury free gas sample.

15. The method according to claim 11, further comprising calibrating the detector using an optical flexible calibrating cell comprising liquid mercury.

16. The method according to claim 13, wherein calibrating the detector comprises measuring the concentration of the liquid mercury at a fixed temperature.

17. The method according to claim 12, wherein the mercury free gas sample is provided by removing the mercury from a second gas sample using a gold trap.

18. The method according to claim 11, wherein measuring the mercury content of the gas in the gas production line may be preformed continuously and in real time as gas is flowing through the gas production line.
